(19) United States
(12) Patent Application Publication
(10) Pub. No.: US 2007/0016511 A1
(43) Pub. Date: Jan. 18, 2007

(54) Method for facilitating the sale of a commodity

(76) Inventors: Michael Walsh, Downers Grove, IL (US); Richard Sandor, Chicago, IL (US)

Correspondence Address: WINSTON & STRAWN LLP;PATENT DEPARTMENT, 1700 K STREET, N.W., WASHINGTON, DC, 20006, US

(21) Appl. No.: 11/258,195

(22) Filed: Oct. 26, 2005

Related U.S. Application Data
(60) Provisional application No. 60/622,518, filed on Oct. 27, 2004.

(51) Int. Cl. G06Q 40/00

(52) U.S. Cl. 705/37; 705/35

(57) ABSTRACT

A method for facilitating the future sale of a commodity is described. The technique includes creating a tradable when-allocated allowance voucher, and selling the voucher at a set present price to a buyer who desires to acquire the amounts of the commodity at the future date. The voucher represents allocated allowance amounts of a commodity that is expected to be available at a future date.

### REFERENCE TO RELATED APPLICATIONS

This application claims the benefit under 35 U.S.C. §119(e) of U.S. Patent Application No. 60/622,518, filed on Oct. 27, 2004.

### BACKGROUND

The present invention generally relates to a method and system for facilitating transactions involving immediate payment for future delivery of a commodity or service that is not currently available for delivery. One version of this invention pertains to a when-allocated allowance voucher created by an entity, wherein the transferable voucher represents amounts of a commodity such as greenhouse gas emissions allowances that are expected to be available at a future date. The entity can sell the voucher at a set price to a buyer who desires to acquire the amounts of the commodity at the future date.

The world's environment faces significant threats from anthropogenic or “human-caused” releases of greenhouse gases to the atmosphere. Greenhouse gases, such as water vapor, carbon dioxide; tropospheric ozone, nitrous oxide, and methane, are generally transparent to solar radiation but opaque to longwave radiation, thus preventing longwave radiation energy from leaving the atmosphere. The net effect of greenhouse gases in the atmosphere is a trapping of absorbed radiation and a tendency to warm the planet's surface.

Greenhouse gases can be released, for example, by the release of carbon dioxide during fossil fuel combustion. Thus, automobiles, factories, and other devices that combust fuel release carbon dioxide gases into the atmosphere. However, greenhouse gases can also be released by more natural means. For example, farmers may till farmland such that carbon dioxide from the tilled ground is released into the air. The removal of forest stands, or deforestation, can also result in the release of greenhouse gases.

The rapid increase in the concentration of greenhouse gases in the earth's atmosphere caused by human activity increases the risk of fundamental and costly changes in the earth's climate system. For example, the changes may include more severe drought/precipitation cycles, longer and more extreme heat waves, the spread of tropical diseases, damage to vegetation and agricultural systems, and threats to coastlines and property due to higher sea levels and storm surges.

In the 1980's, the United States implemented an emissions trading system to phase out lead from motor fuel. This effort was followed by a highly successful U.S. Environmental Protection Agency (EPA) sulfur dioxide (SO₂) emissions trading program. To reduce acid rain, an overall cap on SO₂ emissions was imposed on electric power plants. Utilities that found it expensive to cut sulfur emissions could buy allowances from utilities that make extraordinary cuts at low cost.

Due to the government mandates and flexibility allowed through the emissions trading mechanism, the SO₂ program has been successful. Emissions were reduced faster than required and costs were far below most forecasts. There has also been steady growth in the trading of allowances, from 700,000 tons in 1995 to approximately 12 million tons in 2001. The SO₂ emissions market has now reached a value of approximately $5 billion each year for registered trades.

The environmental and economic success of the U.S. sulfur dioxide allowance trading program to reduce acid rain, as well as other similar markets, provides evidence of the benefits of emissions trading on a large-scale. Emissions trading introduces scarcity by establishing limits on overall emissions, specifying firm-level limits, and allowing those who can cut emissions at low cost to make extra cuts. Companies facing high costs to cut emissions can comply by purchasing tradable emission rights from those who make extra cuts. The market in a property-like instrument, termed an emission allowance, helps assure efficient use of the limited resource (the environment) and yields a price that signals the value society places on use of the environment. That price represents the financial reward paid to those who reduce emissions, and also indicates the value of creating innovative pollution reduction techniques.

Several governments are implementing formal greenhouse gas markets, including the U.K., Denmark, and the Netherlands. The European Union has established the framework for a carbon dioxide emissions trading system to be employed starting in early 2005. The European Union Directive establishes an initial phase market in advance of a broader and more comprehensive greenhouse gas emissions trading system among energy and industrial facilities in its member states starting in 2008. Consequently, a number of states, provinces, exchanges and multilateral institutions have made detailed preparations for trading.

In anticipation of greenhouse gas trading, European entities such as large industrial companies (power generating plants, chemical plants, etc.) that will each be given a predetermined amount of carbon dioxide emission allowances issued in the European Union Emissions Trading scheme for the years 2005, 2006 and 2007, have been eager to buy and sell the allowances. However, the tradable emission allowances will be placed into registry accounts of individual emission sources (such as electric power plants) early in each of the years 2005, 2006 and 2007. An entity may decide to sell some or all of the emission allowances it is scheduled to be allocated before it in fact receives the allowances for a number of reasons. For example, the entity may anticipate that their factory or plant will be efficient in a particular year, and thus that they will not need the entire amount of emission allowances allocated to them for that year. Alternately, the entity may wish to speculate that the value of the carbon dioxide emission allowances will fall in the future so that any of their allowances that they sell now could be repurchased at a later date from the same buyer or from others at a lower price, in a quantity sufficient to cover any emissions overages that they may have.

At the present time, customized forward contracts and promissory notes are being used by entities to sell their emissions allowance to a buyer. In such a transaction, the buyer may or may not pay a fraction of the value of the actual emission allowances in the present in exchange for a promise from the entity that the agreed upon amount of emission allowances will be transferred to the buyer once the entity receives the emission allowance in their registry account. Once the transfer of issued allowances takes place, the buyer typically makes additional payment to the seller to cover the agreed upon value of the emission allowance credits set forth in the promissory note.

Such a transaction has several disadvantages. In particular, each transaction can have unique contractual terms, thus raising the cost and time required to consummate a transaction. In addition, the nature of the promissory note requires that the seller take a credit risk that the buyer will actually be able to pay the full amount at some future date, and the buyer faces a risk that the seller will fail to perform. In addition, for each transaction each party must establish anew that it finds the counterparty to be an acceptable credit risk. Forward contracts and promissory notes are typically not transferable, which impedes the ability of the buyer in such an agreement to resell the promised commodity or service or to otherwise terminate its commitment to purchase the commodity or service. Moreover, the promissory note may include restrictions concerning reselling the emission allowances, such as a right of first refusal. It also takes a relatively long time to negotiate a promissory note agreement, thus hindering the abilities of the parties to rapidly conclude such arrangements. Forward contracts and promissory notes do not typically provide for immediate payment of purchase price to the seller. This means the seller is unable to immediately use the sales proceeds for investments in assets that can produce the commodity or service to be provided in the future.

Thus, there exists a need for an improved method and system for easily and efficiently trading commodities and services, with one example being emission allowances to be issued in the future.

### SUMMARY OF THE INVENTION

The invention now remedies the deficiencies of the prior art and provides methods for enabling trading of commodities and to facilitate compliance with various commodity requirement mandates.

In one aspect, the invention relates to a method for facilitating the future sale of a commodity, by creating a tradable when-allocated allowance voucher wherein the voucher represents allocated allowance amounts of a commodity that is expected to be available at a future date; and then selling the voucher at a set present price to a buyer who desires to acquire the amounts of the commodity at the future date. The method can also include reselling all or a portion of the voucher to at least one other buyer without restriction.

In some variations of the method, the allocated allowance voucher expires after a predetermined amount of time, while in other variations, the allocated allowance voucher does not expire. These expirations generally depend upon the commodity, which can be at least one of electricity, foodstuffs (e.g., crops), and emission allowances, preferably greenhouse gas emission allowances. For example, when the commodity is electricity, a future power voucher is created that relates to delivery of specified quantities of electricity within certain specified time periods, and the power voucher expires on a set date. Also, the future power voucher can be used to represent a predetermined amount of megawatt hours to be delivered within a predetermined time frame.

The method also preferably includes approving an entity as an issuer of the voucher. The price for the commodity can be set by the issuer according to at least one predetermined condition. In one embodiment, a regulatory organization approves the entity. Generally, the this approval is based on predetermined criteria including at least one of creditworthiness, the capability of the issuer to fulfill commitments to provide the commodity to be delivered in accordance with provisions of the voucher, and membership in the regulatory organization. The regulatory organization may be, for example, the European Climate Exchange.

In a preferred embodiment, the method also includes reporting all sales of all or a portion of the voucher to a central regulatory organization. The central regulatory organization typically monitors and approves all transfers and redemptions of the voucher. Generally, the buyer sends a redemption notice to the issuer in an allocation year. The method preferably also includes either transmitting emission allowances from the issuer to a registry account of the buyer or matching allocating emission allowance information in a registry of the issuer with that provided by the buyer.

Another aspect of the invention relates to a method for facilitating compliance with emission reduction mandates by creating a when-allocated emission allowance voucher, wherein the voucher represents allocated amounts of emission allowances that are expected to be available at a future date, and selling the voucher at a set present price to a buyer who desires to acquire the amounts of the emission allowances at the future date. The method preferably also includes approving an entity as an issuer of the voucher. In this method, the issuer can usually utilize revenue realized from the sale of the voucher to comply with the reduction mandates.

Another aspect of the invention relates to a freely-transferable when-allocated allowance voucher representing amounts of emissions allowances that are expected to be available at a future date. Preferably, this voucher is in electronic form for trading over a network.

### BRIEF DESCRIPTION OF THE DRAWINGS

FIG. 1 illustrates an example of a when-allocated allowance voucher (WAAV) according to the invention.

FIG. 2 is a simplified block diagram of an emissions reduction and trading system that may be used to trade when-allocated allowance vouchers like that illustrated in FIG. 1.

FIG. 3 is a simplified block diagram illustrating an implementation of a method according to the invention for an approved issuer to sell a when-allocated allowance voucher to a buyer.

FIG. 4 is a simplified block diagram illustrating an implementation of a method according to the invention for a buyer to redeem a when-allocated allowance voucher.

Like numerals in the various drawings indicate like elements.

### DETAILED DESCRIPTION OF THE PREFERRED EMBODIMENTS

The present invention relates to a method for facilitating the future sale of a commodity, and a non-limiting example is given below in the context of a carbon dioxide emission allowance (or greenhouse gas emission allowance) allocation system. The countries of the European Union have agreed to limit carbon dioxide emissions starting in 2005 according to a predetermined schedule. Each country in the European Union has been apportioned emission allowances that it can allocate to industrial companies, such as power generating plants, and the emission allowance amounts have been publicized. In particular, the European Union countries have set the allocated emission allowances for the years 2005 to 2008 and apparently will continue to do so for future years.

Industrial companies and other entities in the European Union countries have been notified of the amount of their emissions allowance for the next few years, and some wish to take advantage of their emissions allowance to raise working capital for use in complying with their emission reduction mandates. For example, with the revenues raised from the sale of some or all of their emissions allowance, an entity could purchase equipment to reduce emissions, or could reinvest the revenues to become a more efficient producer which results in reducing emissions, or might use the revenues to purchase emission allowances from others. For these reasons, some entities wish to execute contracts to trade their emission allowances before they are allocated to their registry accounts rather than when it is actually received at a future date.

The present invention concerns creation of a when-allocated allowance voucher (“WAAV”) by an entity that has already been notified of the emission allowance that will be issued to them, but has not yet received the emission allowances in its account. It is contemplated that such allocated WAAVs can be easily and efficiently traded by entities to other entities or interested third parties. For example, when an entity receives notice of its emission allowance allocation schedule by the Member State of the European Union, the entity can create a WAAV that represents at least a portion, such as 100,000 tons of carbon dioxide emissions, of an amount of emission allowances that is expected to be available at a future date. The entity then sells the WAAV at a set present price to a buyer who desires to acquire the amounts of the emission allowances at the future date. The voucher could be divided into smaller denominations, such as 10,000 ton units, for resale if required. The seller may use the revenues realized from the sale of the when-allocated allowance voucher to purchase equipment that will enable it to comply with the emissions reduction mandates.

The when-allocated allowance voucher (WAAV) is a new, readily transferable instrument, issued by an entity approved by a regulatory organization, such as the European Climate Exchange (“ECX”). The voucher entitles its holder to receive from the issuer a specified quantity of carbon dioxide emission allowances issued in the European Union Emissions Trading Scheme. The WAAVs can be exercised for delivery only after the Member States of the European Union have issued the specified allowance series (as designated by Allocation Year, e.g. 2005, 2006, 2007) to registry accounts. Such a system would promote the goal of allowing greenhouse gas reduction objectives to be realized at lowest possible cost by enhancing the ability to use the allowance market to obtain upfront financing, by fostering a market in high-credit quality secondary trade involving WAAVs, and by generally reducing the transaction costs.

FIG. 1 illustrates an example of an allocated WAAV 2 entitled “When-Allocated CO₂ Emission Allowances Voucher.” As shown, fields are included for the entity that is the WAAV Issuer to identify itself 3, to include an issue date 4, to assign a serial number range 5, to set an allowance quantity 6 and to specify an allowance allocation year 7.

Upon tender of a WAAV 2 to its Issuer, as recited in the promissory field 8, the Issuer shall transfer the emissions allowance for the specified Allocation Year (or earlier Allocation Year) to a registry account specified by the bearer of the WAAV. All issued WAAVs will be registered with a regulatory agency, such as the European Climate Exchange (ECX), and all transfers of these instruments shall be reported to ECX as per ECX rules, as will be explained below.

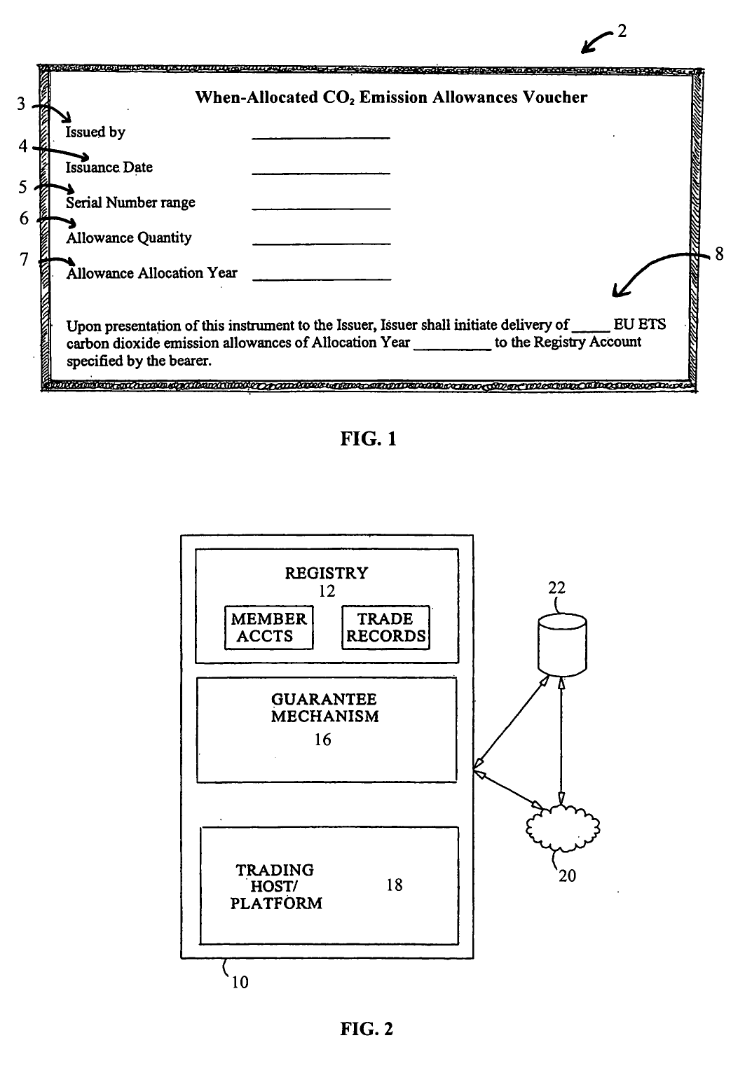

FIG. 2 is a simplified block diagram of an emissions reduction and trading system 10. The system 10 can include a registry 12, a guarantee mechanism 16, and a trading host or platform 18. The system 10 can be coupled to a network 20, such as the Internet or any other public or private network or connections of computing devices. The system 10 can be communicatively coupled to an emissions database 22, either directly or via the network 20.

In an embodiment, a portion of the registry 12 serves as the official record of WAAVs of each participant or entity in the commodity market managed by the system 10. Sales or trades of the WAAVs become officially acknowledged for compliance purposes only when they are reported by the buyer and by the seller to the registry 12, as will be explained below. The registry 12 can also hold other types of Carbon Financial Instruments, such as exchange allowances (XAs), exchange emission offsets (XOs) generated by mitigation projects, and exchange early action credits (XEs). In an implementation, each instrument represents one hundred metric tons of CO₂ and is designated with a specific annual vintage. Each of these instruments is recognized as equivalent when surrendered for compliance (which may be subject to certain constraints), and Carbon Financial Instruments may be used in compliance in their designated vintage year or in later years.

In an exemplary embodiment, the registry 12 is designed to provide secure Internet access by entities or participants to their own accounts. The registry 12 may be configured to provide access of accounts by the public, but this access would be on a read-only basis. Preferably, the registry 12 is configured with the ability to interface with registries in other greenhouse gas markets. The registry 12 is linked to the trading platform 18 and financial guarantee mechanism 16. The combination of these three components provides a clearinghouse system.

The guarantee mechanism 16 enhances market performance by ensuring that those who conduct sales of Carbon Financial Instruments on the trading platform 18 receive next-day payment even if the buyer fails to execute the payment process. This mechanism allows for anonymous trading by eliminating the need to address the credit worthiness of buyers. Non-payment risk is eliminated, thus removing a transaction cost. This feature allows the participation in trading by liquidity providers (including “market makers”), who can stand ready to promptly buy and sell. The presence of standing buyers and sellers increases trading activity, which improves the economic efficiency of the price discovery process. In addition, the ability to trade anonymously allows members to post bids and offers and execute trades without revealing their trading strategies. The guarantee mechanism 16 eliminates the risk that a buyer may fail to make payment.

The trading platform 18 is an electronic mechanism for hosting market trading that provides participants with a central location that facilitates trading, and publicly reveals price information. The trading platform 18 reduces the cost of locating trading counter parties and finalizing trades, an important benefit in a new market.

In a contemplated example, the allocated WAAVs would be issued for allocation years 2005 through 2012. In a preferred embodiment, the European Climate Exchange (ECX) would designate selected industrial and financial entities as approved WAAV Issuers. The criteria for approving an industrial and/or a financial entity as an WAAV Issuer would be based on the entity's creditworthiness and certain other requirements, such as membership in the ECX. Spot market trade in these instruments would involve prompt payment (by the next day) by the purchaser, and prompt delivery of the WAAV by the issuer and/or seller. Upon expiration of ECX futures contracts, WAAVs are to be delivered by entities that are short at futures contract expiration to those who are long.

The WAAVs are also to be designated by the allocation year, and shall be redeemable by bearer against the issuer at any time subsequent to determination by ECX that sufficient allocation of allowances has been completed by European Union Member states. This determination may be made by an ECX Committee that includes representatives of the WAAV Issuers, or by some other agency or organization that may be appointed by a European Union committee or other regulatory body.

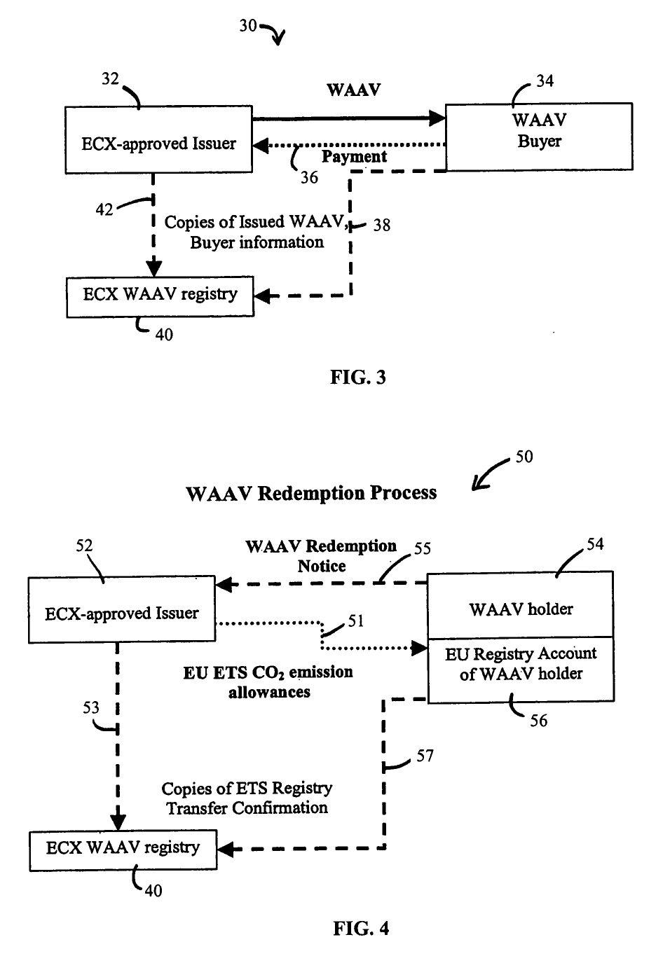

The WAAVs can also be freely transferred by a buyer to another entity. All transferors and transferees of WAAVs must each report such transfers to the ECX WAAV Registry, which will be explained in detail below with reference to FIGS. 3 and 4.

FIG. 3 is a simplified block diagram 30 illustrating how an approved WAAV Issuer 32 sells an WAAV to a buyer 34. In particular, after a member of the ECX has been notified of its emission allocation for a particular year, if that member is an approved WAAV Issuer, it can create an WAAV representing all or a portion of the emissions allowance allocated to it for that year and offer it for sale at a set price. The WAAV Issuer is responsible for setting a price, which could be determined as a function of their assessment of market conditions concerning futures contracts for allocated emissions allowances, and any other information deemed to be pertinent. The WAAV buyer then promptly tenders payment 36 for the WAAV, and notifies 38 the ECX WAAV Registry 40 of the transaction. The WAAV Issuer 32 also notifies 42 the ECX WAAV Registry 40 of the transaction. The information from the Issuer and from the buyer is received by the WAAV Registry and matched to ensure that both the buyer and seller agree concerning the amount of emissions allowances to be transferred. This same process is followed if the seller decides to sell the WAAV to a third party in the future, in which case both the transferor and transferee must report the transaction to the ECX WAAV Registry 40.

FIG. 4 is a simplified block diagram 50 illustrating the WAAV redemption process. In particular, a redemption notice is sent 55 from the WAAV holder 54 to the WAAV Issuer 52 in the allocation year in which the issuer has possession of the European Union emission allowance. The WAAV Issuer 52 then transmits 51 the European Union emission allowance, in an amount equal to that recited on the WAAV, to the European Union registry account 56 of the WAAV holder 54. The WAAV Issuer 52 also notifies 53 the ECX WAAV Registry 40 of the transaction. The buyer also notifies 57 the ECX WAAV Registry 40 of the transaction. The information received by the EXC WAAV Registry 40 in this manner is then checked against the allocated emissions allowance information already residing in the WAAV Registry 40 concerning transactions connected with that WAAV and the Issuer. If the information matches, then the transaction is permitted to stand. If the information does not match, or if there is a disagreement between the WAAV holder and the WAAV Issuer concerning the amount of emissions allowance that should be transferred, then the ECX shall implement an investigation to determine if there have been any fraudulent dealings. Under such circumstances, the ECX may also implement a settlement process, such as binding arbitration, to determine the correct amount of the emissions allowance that should be transferred, or whether any emissions allowance should be transferred.

There are several advantages when using such an WAAV system. First, the WAAV Issuer receives payment right away for its allocated emissions allowance, in the present, without having to actually have the emissions credit in its account. This removes the credit risk that the WAAV Issuer would have had to assume concerning a buyer if a futures contract or promissory note was used instead. Second, since only approved Issuers can create WAAVs, the buyer does not need to run a credit check or negotiate a customized contract that covers all contingencies when buying an WAAV. However, a buyer does take on some risk concerning the capability of the WAAV Issuer to provide the actual emissions allowance. But even this risk is minimized, as WAAV Issuers are creditworthy and trustworthy entities, such as power companies. Thus, the buyer of the WAAV is holding a claim to an emissions allowance. Moreover, the buyer has advantageously acquired an instrument that can be resold without restriction in the present or in the future.

Use of WAAVs addresses an imperfection in the allocated emissions trading program created by the regulators of the system. The vouchers can be equated to a form of currency for those wishing to buy and sell allocated emissions allowances. An additional benefit of using WAAVs is that third party entities, such as financial institutions, which cannot actually use them, could buy them as an investment for resale to other entities that would actually need them in the future, thus creating an expanded market for such vouchers. One skilled in the art would understand that, although an when-allocated allowance voucher system has been described above in the context of a greenhouse gas market, such a voucher could be used in other industries or commodity markets. For example, it is contemplated that a similar voucher created for application to future delivery of electric power could be issued by various electric power companies in the electric power generation industry. Each electric power company could issue a limited number of such vouchers that would include a promise to provide a preset amount of megawatt hours of electricity on a specified electricity grid during a predetermined time period. It is contemplated that the electric power vouchers would be set to expire by a certain date. Time limitations on electric power vouchers would be required because a set amount of megawatt hours at peak times, such as in July when the weather is hot and demand is high, is worth more than the same amount of megawatt hours in October when demand is low. In addition, the cost of generating electric power may fluctuate and may increase as a result of rising fuel prices, but the holder of the voucher would have a right to receive electric power (having already paid for the electric power) from the issuer of the voucher regardless of fuel price levels or other conditions that may change in the electric power market. In contrast, a when-allocated allowance voucher for greenhouse gas emissions may not require an expiration date, and thus may be permitted to carry over from one year to the next, and/or to never expire, as different considerations apply.

Note any of the functions, method steps or processes of the invention can be performed by one or more hardware or software devices, processes or other entities. These entities can reside in the same location or can reside remotely as, for example, entities interconnected by a digital network such as the Internet, a local area network (LAN), campus or home network, standalone system, etc. Although functions may have been described as occurring simultaneously, immediately or sequentially, other embodiments may perform the functions, steps or processes in a different order, or at substantially different times with respect to execution of other functions, steps or processes.

It will be understood that the systems and software described herein include, either explicitly or implicitly, software implemented on computers or other appropriate hardware, including such other intelligent data processing devices having processors, data storage means, and the ability to support an operating system, with or without user interfaces, for example, file servers, as may be useful in implementing this invention.

Preferred embodiments of the invention provide program product, which can cause a general-purpose computer to operate as a special-purpose computer, in accordance with the disclosure herein. Such program product implemented on a general-purpose computer constitutes an electronic customizing machine which can interact with a magnetically or optically cooperative computer-based input device enabling the computer to be customized as a special purpose computer, according to the contents of the software. To cause a computer to operate in such a customized, special-purpose mode, the software of the invention can be installed by a user or some other person, and will usually interact efficiently with the device on which it resides to provide the desired special-purpose functions or qualities, but only after the selection of configuration parameters which are often unique to the operating system(s) used by the computer. When so configured, the special-purpose computer device has an enhanced value, especially to the professional users for whom it may be intended.

It is to be understood that the terms “computer,” “server,” “data storage means,” as well as cognate terms, denote either physical or logical instances of those entities. For instance, a computer, data storage means and server may be implemented as separate physical entities or as one physical entity performing logically separate functions. Similarly two servers may be implemented as separate physical entities or as one physical entity performing logically separate functions. Also, a computer may be envisaged as a “terminal” which will be understood to include mobile devices (e.g. mobile phones or PDAs) as well as stationary computers.

It should be understood that the embodiments presented herein are merely examples of a tradable voucher according to the invention. It is contemplated that a full range of tradable vouchers can be issued and sold in the near-term to provide the holder of the voucher with the right to receive a commodity or service flow in the future. Furthermore, the vouchers can be traded in electronic form in a variety of ways, over networks, be e-mail, of in other ways that are known to skilled artisans. Thus, although a particular embodiments have been chosen to illustrate the invention, it will be understood by those of ordinary skill in the art that various changes and modifications can be made without departing from the spirit and scope of the invention as defined by the claims.

What is claimed is:

1. A computer-implemented method for facilitating the future sale of a commodity, which comprises:
creating a tradable when-allocated allowance voucher that represents allocated allowance amounts of a commodity which is expected to be available at a future date; and
selling the voucher at a set present price to a buyer who desires to acquire the amounts of the commodity at the future date.

2. The method of claim 1, further comprising reselling all or a portion of the voucher to at least one other buyer without restriction.

3. The method of claim 1, wherein the voucher expires after a predetermined amount of time.

4. The method of claim 1, wherein the voucher does not expire.

5. The method of claim 1, wherein the commodity is at least one of electricity, foodstuffs, and carbon emissions allowances.

6. The method of claim 1, wherein the commodity is electricity, and an electric power voucher is created that expires on a set date.

7. The method of claim 6, wherein the electric power voucher represents a predetermined amount of megawatt hours to be delivered within a predetermined time frame.

8. The method of claim 1, further comprising approving an entity as an issuer of the voucher.

9. The method of claim 8, wherein the price for the commodity is set by the issuer according to at least one predetermined condition.

10. The method of claim 8, wherein a regulatory organization approves the entity.

11. The method of claim 10, wherein approval is based on predetermined criteria including at least one of creditworthiness, the capability of the issuer to fulfill commitments to provide the commodity to be delivered in accordance with provisions of the voucher, and membership in the regulatory organization.

12. The method of claim 10, wherein the regulatory organization is the European Climate Exchange.

13. The method of claim 8, further comprising reporting all sales of all or a portion of the voucher to a central regulatory organization.

14. The method of claim 13, wherein the central regulatory organization monitors and approves all transfers of the voucher, and redeems the voucher.

15. The method of claim 14, wherein the buyer sends a redemption notice to the issuer in an allocation year.

16. The method of claim 14, further comprising transmitting emission allowances from the issuer to a registry account of the buyer.

17. The method of claim 16, further comprising matching allocated emissions allowance information in a registry of the issuer with that provided by the buyer.

18. A computer-implemented method for facilitating compliance with emissions reduction mandates, which comprises:
creating a when-allocated emission allowance voucher that represents amounts of emission allowances which are expected to be available at a future date; and
selling the voucher at a set present price to a buyer who desires to acquire the amounts of the emissions allowances at the future date.

19. The method of claim 18, further comprising approving an entity as an issuer of the voucher.

20. The method of claim 19, wherein the issuer utilizes revenue realized from the sale of the voucher to comply with the reduction mandates.

21. A freely-transferable when-allocated allowance voucher representing amounts of emissions allowances that are expected to be available at a future date.

22. The voucher of claim 21 in electronic form for trading over a network.
